(19) United States
(12) Patent Application Publication
(10) Pub. No.: US 2013/0289858 A1
(43) Pub. Date: Oct. 31, 2013

(54) METHOD FOR CONTROLLING AND COMMUNICATING WITH A SWARM OF AUTONOMOUS VEHICLES USING ONE-TOUCH OR ONE-CLICK GESTURES FROM A MOBILE PLATFORM

(71) Applicants: Alain Anthony Mangiat, Demarest, NJ (US); Unnikrishna Sreedharan Pillai, Harrington Park, NJ (US); Jonathan Sheldon Kupferstein, Lawrence, NY (US)

(72) Inventors: Alain Anthony Mangiat, Demarest, NJ (US); Unnikrishna Sreedharan Pillai, Harrington Park, NJ (US); Jonathan Sheldon Kupferstein, Lawrence, NY (US)

(21) Appl. No.: 13/455,594

(22) Filed: Apr. 25, 2012

(51) Int. Cl. G08G 1/00

(52) U.S. Cl. 701/117

(57) ABSTRACT

A method for controlling a swarm of autonomous vehicles to perform a multitude of tasks using either a one touch or a single gesture/action command. These commands may include sending the swarm on an escort mission, protecting a convoy, distributed surveillance, search and rescue, returning to a base, or general travel to a point as a swarm. A gesture to initiate a command may include a simple touch of a button, drawing a shape on the screen, a voice command, shaking the unit, or pressing a physical button on or attached to the mobile platform.

### FIELD OF THE INVENTION

This invention relates to methods for communicating and issuing commands to autonomous vehicles.

### BACKGROUND OF THE INVENTION

Swarms of autonomous vehicles on land, sea, and air are increasingly used for various civilian and military missions. The use of swarms of autonomous vehicles are attractive when the operations are routine—search, rescue, and surveillance—such as border patrol, scouting for moving vehicles in remote areas, or when the mission poses a threat to human life, common in various military situations, or those encountered by law enforcement in the context of narcotics management and drug enforcement operations. Such routine operations can be performed efficiently with a simple way to command and communicate with the swarm.

### SUMMARY OF THE INVENTION

As handheld electronics become more and more sophisticated, they become a go-to method for mobile communication devices. Since a number of mobile electronics such as tablets and smart phones now possess very advanced computer architectures, they can be used for much more than simple communication with a swarm of autonomous vehicles, in accordance with one or more embodiments of the present invention. An entire swarm can be controlled at a very high level, in accordance with one or more embodiments of the present invention using simply one's smart phone. This enables an owner of a device such as a tablet computer or smart phone the ability to intelligently control a swarm of autonomous vehicles anywhere on the planet with minimal effort.

Tablet computers and smart phones are just two examples of portable devices equipped with advanced computing hardware. The amount of customization on these devices allows them to be used in an infinite number of ways. Taking advantage of the flexibility and power of these devices allows the user to have complete control over a swarm of autonomous vehicles anywhere they go. One or more embodiments of the present invention provide a method for efficiently controlling and communicating with a swarm of unmanned autonomous vehicles using a portable device.

Controlling a swarm of vehicles is an incredibly high level operation; however the ability to develop custom computer software for many of today's portable devices allows this operation to become streamlined for the user. Amazon.com (trademarked) provides the ability to purchase items with one click. By allowing a customer to bypass the multiple screens full of user entered information, the one click purchase makes Amazon's (trademarked) consumers more likely to use the site as their primary source for online purchasing due to its ease and efficiency. In accordance with at least one embodiment of the present invention, a similar concept is applied to controlling a swarm of autonomous vehicles. Many controls systems are burdened with very complex and difficult to navigate user interfaces (UI). One or more embodiments of the present invention provide a method for controlling and communicating with a swarm of autonomous vehicles using one touch/click gestures on a portable device.

Using a simple UI (user interface), in at least one embodiment, a user is presented with a series of buttons, and the user simply needs to touch/click a desired command they wish to send to the swarm. A computer software application installed on the portable device is programmed by a computer program stored in computer memory to then automatically issue appropriate commands based either on pre-entered information, or information collected by onboard sensors (onboard one or more autonomous vehicles of a swarm).

An example of a button, on a display screen of a portable device, as provided by a computer software application, in accordance with an embodiment of the present invention, is a button to send commands for general area surveillance. When pressed, a computer processor of the portable device may use information such as the location of the one or more autonomous vehicles and the location of the portable device (acquired by GPS (global positioning satellite), desired surveillance radius (preset by the user), and desired length of the mission (preset by the user), which may be stored in computer memory of the portable device, to automatically send the drones (also called autonomous vehicles) on a surveillance mission with just the one touch/click. The one touch gesture can be as simple as touching or tapping a screen with a finger, performing a coded voice command such as whistling, a favorite tune or melody, moving or wiggiling the handheld device in a specific way to activate specific tasks such as distributed survelliance, escort a parent vehicle, search and rescue, and move as a convoy. In one or more embodiments, the one-touch or one-gesture action can be replaced by or may include two-touch and multiple-touch or multiple-gesture commands, and such multiple touch or multiple gesture actions can be coded in computer software to appear as if they were a one-touch or one-gesture command on the screen.

In another embodiment of the present invention, in a scenario where it is necessary to protect a large naval vessel, thousands of autonomous mini-aquatic vehicles would be distributed in a random fashion over a very large area covering thousands of square miles of ocean around the large naval vessel. Each aquatic vehicle, in this example, may be solar-powered and may have hardware to perform a multitude of sensing operations. With GPS (global positioning satellite) communication, the aquatic vehicles transmit/receive data to a nearby satellite and to a central command unit, where the data can be routinely processed to detect any threat, or to be aware of the presence of other ocean bearing vehicles (situational awareness). This allows the central command unit to map the entire ocean on a map with the latest position of all mini-aquatic vehicles getting updated after a set period of time. The mini-aquatic vehicles form a swarm or set of swarms that can be controlled separately or together through their swarm centroid. The swarm centroid may be defined, in one embodiment, as a center of mass of the group of vehicles, and/or the geographic center of the vehicles, wherein each vehicle has a center, and the centroid of the group of vehicles is a geographic center determined from all of the centers of all of the vehicles. The centroid may be determined in the same or a similar manner to the centroid or centroids shown in examples of U.S. patent application Ser. No. 13/372,081, filed on Feb. 13, 2012, which is incorporated by reference herein.

In at least one embodiment, a group of these aquatic vehicles is used to form an “extended escort” to a specific ship, and their swarm-centroid is made to track a path that matches or somewhat matches the path of the ship of interest. Since the swarm-centroid is not a physical entity, the path of the ship itself will not be revealed. In accordance with at least one embodiment of the present application, the captain of any ship can order an escort covering thousands of miles using hundreds of such aquatic vehicles already floating in the ocean. The command is given through a portable device, in accordance with an embodiment of the present invention, such as a tablet computer or a smart phone using a one touch gesture. Once a command is given, available vehicles in the nearby ocean can respond to the command and follow the escort order

In at least one embodiment of the present invention, a method is provided which may include providing a user input to a handheld computer device, and using a computer processor to respond to the user input to control a plurality of vehicles, wherein the control of each vehicle of the plurality of vehicles is related to the control of the other vehicles of the plurality of vehicles.

The user input may include touching a screen of the handheld computer device. The user input may be one touch of a screen of the handheld computer device. The user input may be a sound provided through a sound input device of the handheld computer device. The user input may include a shape drawn on a screen of the handheld computer device. The user input may include shaking of the handheld computer device.

The plurality of vehicles may be controlled so that each of the plurality of vehicles stays within a geographic region. Each of the plurality of vehicles may have a current location, so that there are a plurality of current locations, one for each of the plurality of vehicles. The geographic region may be determined, at least in part by, a geographic center which is based on the plurality of current locations. The plurality of vehicles may be controlled so that each vehicle of the plurality of vehicles stays within a first distance from every other vehicle of the plurality of vehicles. The plurality of vehicles are controlled so that each vehicle of the plurality of vehicles stays a second distance away from every other vehicle of the plurality of vehicles. The second distance may be a diameter of a sphere that is centered around a centroid of a combination of all of the plurality of the vehicles.

The method may further include determining a location of each of the plurality of vehicles by the use of a global positioning system, so that a plurality of locations are determined, one corresponding to each of the plurality of vehicles; and controlling each of the plurality of vehicles based on one or more of the plurality of locations.

In at least one embodiment of the present invention a handheld computer device is provided comprising a computer processor, a computer memory, and a computer interactive device for receiving a user input. The computer processor may be programmed by computer software stored in the computer memory to respond to the user input to control a plurality of vehicles, wherein the control of each vehicle of the plurality of vehicles is related to the control of the other vehicles of the plurality of vehicles.

### BRIEF DESCRIPTION OF THE DRAWINGS

FIG. 1A shows an apparatus for a controller in accordance with an embodiment of the present invention;

FIG. 1B shows an apparatus for a drone or autonomous vehicle in accordance with an embodiment of the present invention;

FIG. 2 illustrates an example of a tablet device and how the user interacts with it to issue a one touch/click command;

FIG. 3 illustrates an example of a portable phone and how the user interacts with it to issue a one touch/click command;

FIG. 4 illustrates an example of a receiver/transmitter apparatus which may connect to either the tablet device or the portable phone through a serial port;

FIG. 5 is a flowchart of a flow of information from a handheld device to a single drone;

FIG. 6 is a flowchart of a flow of information from when user interacts with a handheld device, to when the information is transmitted;

FIG. 7 is a flow chart which depicts a single transmitter apparatus on a handheld device communicating with any number of receivers on the autonomous vehicles;

FIG. 8 illustrates an example of a first screen or image displayed on a computer display of the handheld device to issue one touch/click commands to the autonomous vehicles;

FIG. 9 illustrates an example of a second screen or image displayed on a computer display of the handheld device to issue one touch/click commands to the autonomous vehicles;

FIG. 10 shows a plurality of drones, their centroid, and a swarm sphere, as well as a portable device for communicating with the drones, and an image or screen on the portable device;

FIG. 11A is a flow chart that outlines part of a method to be implemented on an autonomous vehicle at least one embodiment of the present invention to update GPS data;

FIG. 11B is a flow chart which outlines part of a method that can be implemented on an autonomous vehicle in at least one embodiment of the present invention to steer the particular autonomous vehicle on a desired course;

FIG. 12 illustrates the method described in FIGS. 11A and 11B;

### BRIEF DESCRIPTION OF THE DRAWINGS

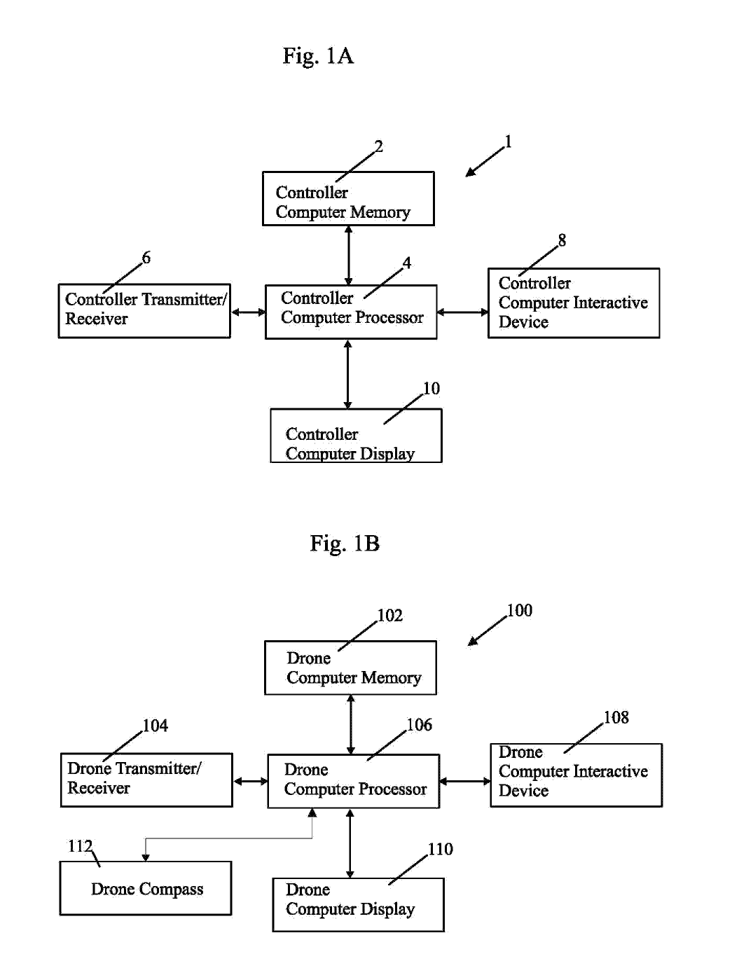

FIG. 1A shows a block diagram of an apparatus 1 in accordance with an embodiment of the present invention. The apparatus 1 includes a controller computer memory 2, a controller computer processor 4, a controller transmitter/receiver 6, a controller computer interactive device 8, and a controller computer display 10. The controller computer memory 2, the controller transmitter/receiver 6, the controller computer interactive device 8, and the controller computer display 10 may communicate with and may be connected by communications links to the controller computer processor 4, such as by hardwired, wireless, optical, and/or any other communications links. The apparatus 1 may be part of or may be installed on a handheld portable computer device, such as a tablet computer, laptop computer, or portable smart phone.

FIG. 1B shows a block diagram of an apparatus 100 in accordance with an embodiment of the present invention. The apparatus 100 includes a drone computer memory 102, a drone computer processor 104, a drone transmitter/receiver 106, a drone computer interactive device 108, a drone computer display 110, and a drone compass 112. The drone computer memory 2, the drone transmitter/receiver 6, the drone computer interactive device 8, the drone computer display 10, and the drone compass 112 may communicate with and may be connected by communications links to the drone computer processor 4, such as by hardwired, wireless, optical, and/or any other communications links. The apparatus 100 may be part of or may be installed on a drone or autonomous vehicle, such as an aerial vehicle or a seagoing vehicle.

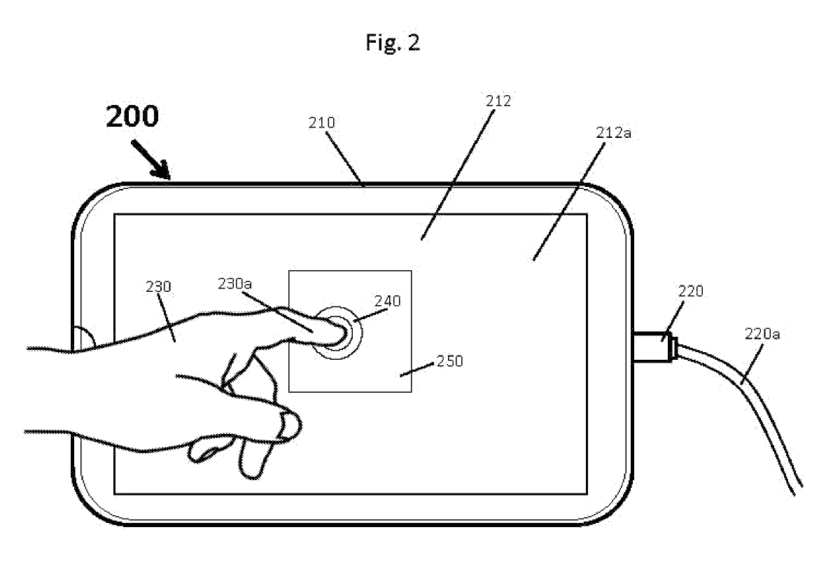

FIG. 2 illustrates a tablet computer 200. The tablet computer 200 may include a housing 210, and a computer display monitor 212. In FIG. 2, an overall image 212a is being displayed on the monitor 212. The apparatus 1 may reside in, be a part of, or be connected to the tablet computer 200, such that the display monitor 212 is the controller computer display 10. There is an overall image 212a displayed on the computer display 212 in FIG. 2, which includes a button, box, area, or partial image, 250, which is part of the overall image 212a. The controller computer interactive device 8, may include the display monitor 10 (212) and further components for sensing when a person has touched the computer display 10 (212) at a certain location, which are known in the art. For example, when a user touches a box area or button 250 of the computer display 10 (212), with a finger 230a of their hand 230, the computer interactive device 8 senses this and provides a signal or signals to the controller computer processor 4. Thus the computer processor 4 has detected the pressing of the box area or “button” 250. Circled areas or rings 240 shown in FIG. 2 may be highlighted or otherwise lit up, when the user touches their finger 230a to the box area or button 250 of the overall image 212a. The tablet computer 200 includes a device 220 and a connector 220a.

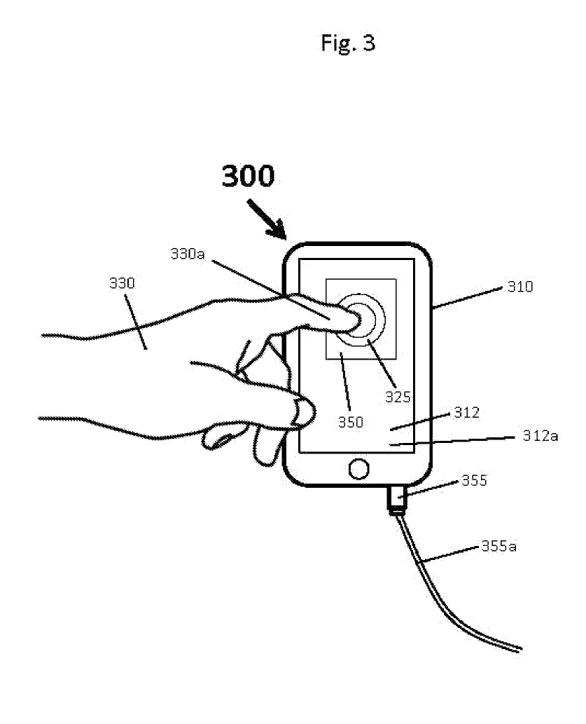

In at least one embodiment of the present invention, the controller computer processor 4 is programmed by computer software stored in the controller computer memory 2 to control a swarm of autonomous vehicles with a one touch gesture. The user's hand, labeled 230 in FIG. 2, is using the tablet computer 200, to activate a one gesture button 250. This button 250, has been activated in FIG. 3 using a touch gesture as signified by the rings or highlights 240 around the fingertip 230a. In at least one embodiment of the present invention, the touching of box area or button 250, is detected by the computer processor 4 and/or the computer interactive device 8 which may include display 212 (10), and the computer processor 4 is programmed by computer software stored in computer memory 2 to activate a series of commands which are transmitted out via wireless signals via controller transmitter/receiver 6 and thereby transmitted to a swarm of autonomous vehicles. The apparatus 100 or a similar to identical apparatus may be installed on or may be a part of each drone or autonomous vehicle. Each drone, may receive the signals or signals from the controller transmitter/receiver 6 via drone transmitter/receiver 104 or analogous drone transmitter/receiver.

FIG. 3 illustrates a mobile smart phone, 300, being used to control a swarm of autonomous vehicles with a one touch gesture. The mobile smart phone 300 may include a housing 310 and a computer display monitor 312. The apparatus 1, shown in FIG. 1A may reside in, be a part of, or be connected to the mobile smart phone 300, such that the display 312 is the controller computer display 10. There is an overall image 312a shown displayed on the computer display 312 in FIG. 3, which includes a button, box, area, or portion 350 which is part of the overall image 312a. The controller computer interactive device 8, may include the display 10 (312) and further components for sensing when a person has touched the computer display 10 (312) at a certain location, which are known in the art. For example, when a user touches a box area or button 350 of the computer display 10 (312), with a finger 330a of their hand 330, the computer interactive device 8 senses this and provides a signal or signals to the controller computer processor 4. Thus the computer processor 4 has detected the pressing of the box area or “button” 350. Circled areas or rings 325 may be highlighted or otherwise lit up, when the user touches their finger 330a to the box area or button 350 of the overal image 312a.

In at least one embodiment of the present invention, the controller computer processor 4 is programmed by computer software stored in the controller computer memory 2 to control a swarm of autonomous vehicles with a one touch gesture. The user's hand, labeled 330 in FIG. 3, is using the smart phone 300, to activate a one gesture button 350. This button 350, has been activated in FIG. 3 using a touch gesture as signified by the rings or highlights 340 around the fingertip 330a. In at least one embodiment of the present invention, the touching of box area or button 350, is detected by the computer processor 4 and/or the computer interactive device 8 which may include display 312 (10), and the computer processor 4 is programmed by computer software stored in computer memory 2 to activate a series of commands which are transmitted out via wireless signals via controller transmitter/receiver 6 and thereby transmitted to a swarm of autonomous vehicles. The apparatus 100 or a similar to identical apparatus may be installed on or may be a part of each drone or autonomous vehicle. Each drone, may receive the signals from the controller transmitter/receiver 6 via drone transmitter/receiver 104 or analogous drone transmitter/receiver. The phone 300 includes a device 355 and a connector 355a (identify 355a in FIG. 3).

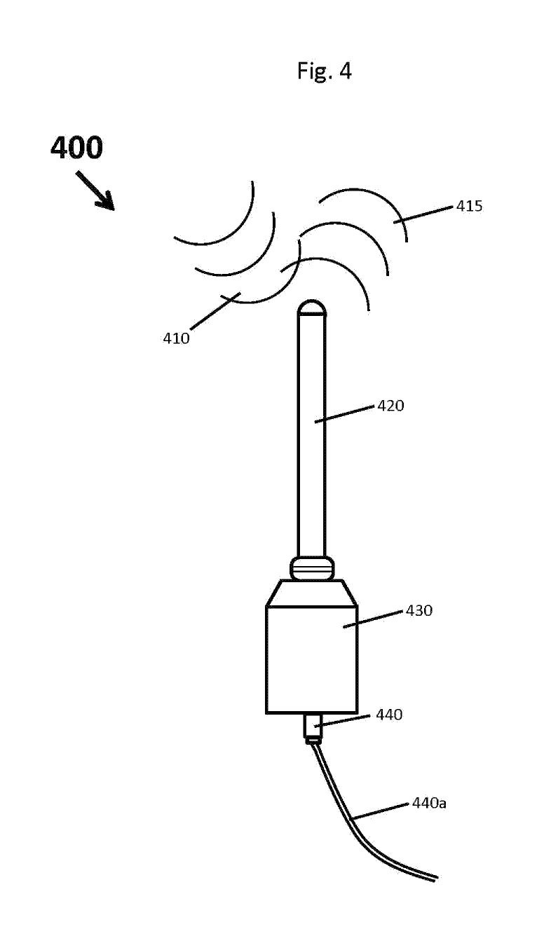

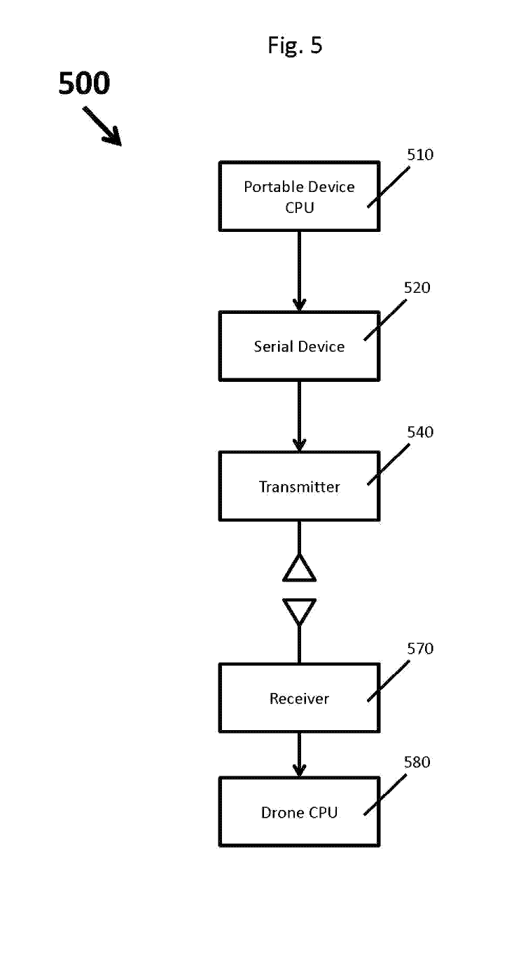

FIG. 4 illustrates an example of a serial device 400 which would allow the tablet computer, such as 200, or a mobile smart phone, such as 300, to receive and transmit data to and from the tablet computer 200 or smart phone 300 in the event such communication hardware is not built-in to the tablet computer 200 or the smart phone 300 device's hardware. The tablet computer 200, shown in FIG. 2 may include the serial device 400, which may include the controller transmitter/receiver 6 shown in FIG. 1A. The smart phone 300, shown in FIG. 3, may also include the serial device 400, which may include the controller transmitter/receiver 6 shown in FIG. 1A. Alternatively, a connector 440a of the serial device 400 may connect to the connector 355a of the phone 300 or to the connector 220a of the tablet computer 200.

The serial device 400 may include cable or connector 440a which may be connected via connector 220a (for tablet computer 200) or connector 355a (for phone 300) to a computer processor of the computer 200 or phone 300, such as computer processor 4 of FIG. 1A. The serial device 400 may also include device 440, device 430, and device 420. The controller computer processor 4 in FIG. 1A, may cause wireless signals to be sent out via the controller transmitter/receiver 6 or cause wireless signals to be received via the controller transmitter/receiver 6. The controller transmitter/receiver 6 may include wire, connector or cable 440a, device 440, device 430, and device 420. The device 420 may be an antenna. The device 430 may be an additional processor. The device 440 may be the USB connector to the mobile device Electromagnetic waves 410 of received wireless signals are shown in FIG. 4 and electromagnetic waves 415 of outgoing wireless signals are shown in FIG. 4. The waves coming, 410, illustrate data being received by the antenna 420, while the outgoing waves, 415, illustrate the data being transmitted by the antenna 420.

FIG. 5 is a flow chart 500 which represents the basic flow of data from the apparatus 1 of FIG. 1A in the tablet computer 200, smart phone 300, or other device, to the apparatus 100 of FIG. 1B, of one of the autonomous vehicles in a swarm of autonomous vehicles. Computer processor 4 is the particular portable device's (i.e. either tablet computer 200 or smart phone 300) central computer processor or central computer processors (CPUs) which processes data and sends it through the controller transmitter/receiver 6 (which may include the serial device 400). The data is sent through the controller transmitter/receiver 6, and collected by the drone transmitter/receiver 104 on one of the autonomous vehicles in a swarm. This received information is then given to the vehicle's computer processor or central processing unit (CPU), 106, for processing.

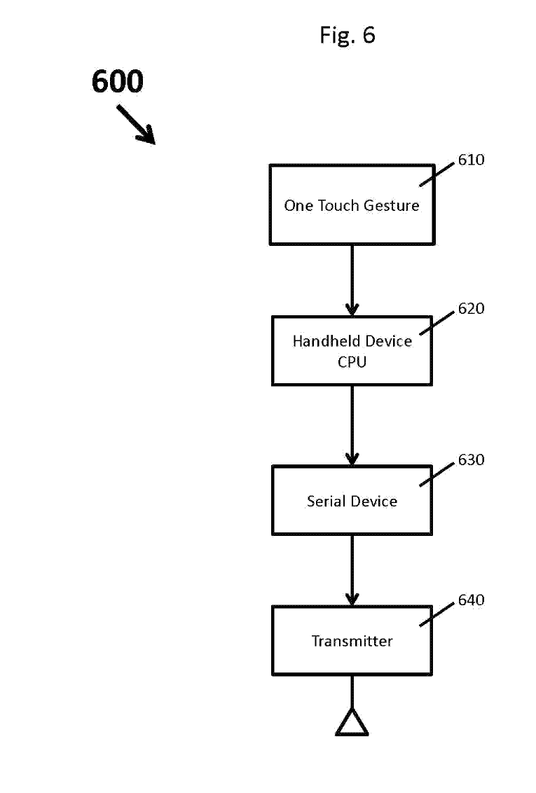

FIG. 6 is a flowchart 600 which represents the flow of outgoing data on a portable device, such as the tablet computer 200 or the smart phone 300. The user activates the data flow using a one touch gesture, 610. Once this gesture is complete the device's CPU, such as controller computer processor 4, is programmed by computer software stored in computer memory 2 to generate data corresponding to that gesture at step 620. This data is then send through the serial device 400 at step 630, and then transmitted at 640 from the controller transmitter/receiver 6, to be received by the drones (or autonomous vehicles) in the swarm of drones.

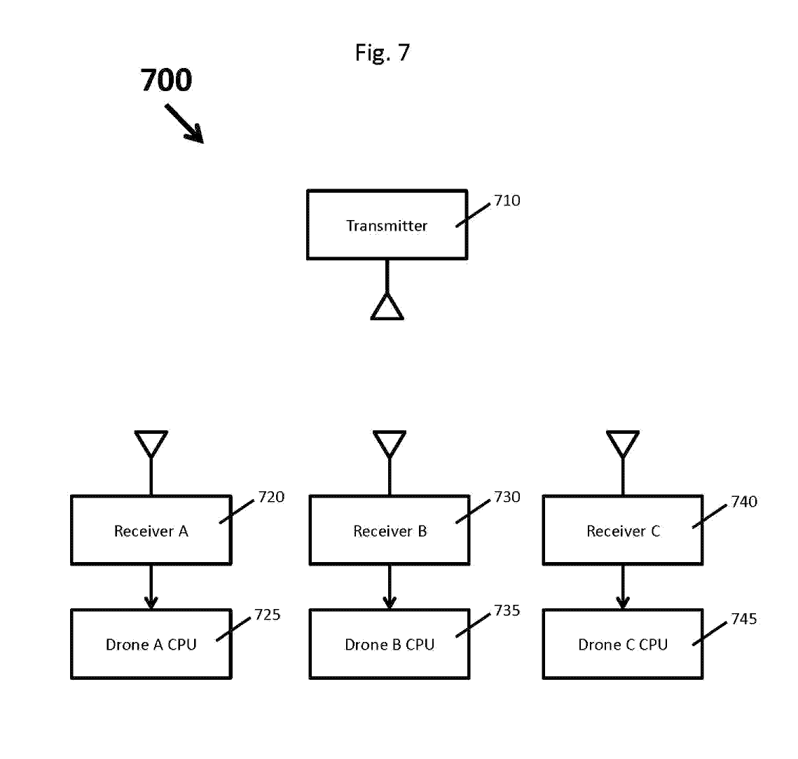

FIG. 7 is a diagram 700 which illustrates a method of transmitting to multiple autonomous vehicles in the swarm simultaneously. The transmitter 710, which may be the controller transmitter/receiver 6, sends a data packet which can be received by any number of receivers in range, such as receivers 720, 730, and 740, each of which may include drone transmitter/receiver 104. The data received is then passed to the respective CPUs on each vehicle, 725, 735, and 745 (each of which may be identical to drone computer processor 106).

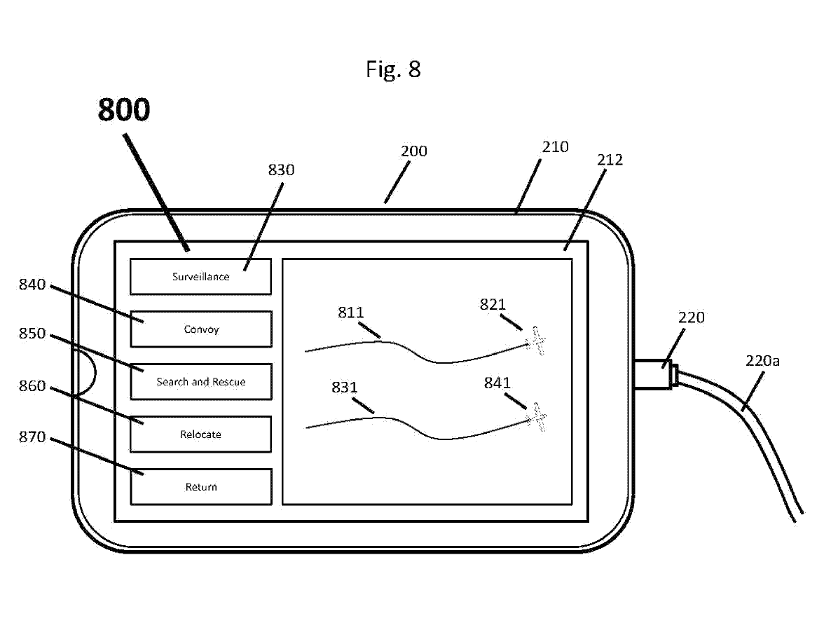

FIG. 8 illustrates an overall image 800 produced on display 212 of the tablet computer 200 connected to the serial device, 220, in accordance with computer software stored in computer memory 2 and implemented by computer processor 4, which implements the one touch gestures for communicating and controlling a swarm of autonomous vehicles. The overall image 800 features five one touch gesture buttons or areas on the overall image 800, namely, 830, 840, 850, 860, and 870. Each of buttons 830, 840, 850, 860, and 870, can be selected by a user touching the button or area on the display 212 to cause the computer processor 4 to issue a different command to the swarm of vehicles such as a surveillance mode for button 830, swarm convoy for button 840, search and rescue for button 850, vehicle relocation for button 860, and return to a safe zone for button 870. When a one touch gesture is activated the computer processor 4 is programmed to display relevant information regarding the mission such as the paths 811 and 831 of two different drones or autonomous vehicles, and the respective locations, 821 and 841 of the two drones or vehicles.

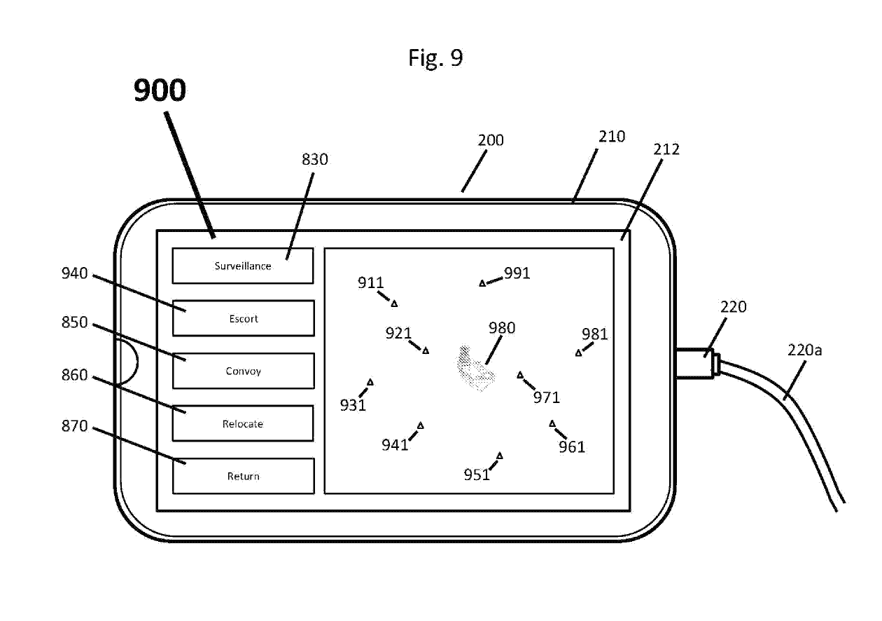

FIG. 9 illustrates an overall image 900 produced on display 212 of the tablet computer 200 connected to the serial device, 220, in accordance with computer software stored in computer memory 2 and implemented by computer processor 4, which implements the one touch gestures for communicating and controlling a swarm of autonomous vehicles. The overall image 900 features five one touch gesture buttons or areas on the screen or image 900, namely, 830, 940, 850, 860, and 870. Each of buttons 830, 940, 850, 860, and 870, can be selected by a user touching the button or area on the display 212 to cause the computer processor 4 to issue a different command to the swarm of vehicles such as a surveillance mode for button 830, escort for button 940, convoy for button 850, relocate for button 860, and return to a safe zone for button 870. When a one touch gesture is activated the computer processor 4 will display relevant information regarding the mission, in this case, the location of an escorted naval ship, 980, and the locations of all the vehicles escorting it, 911, 921, 931, 941, 951, 961, 981, and 991.

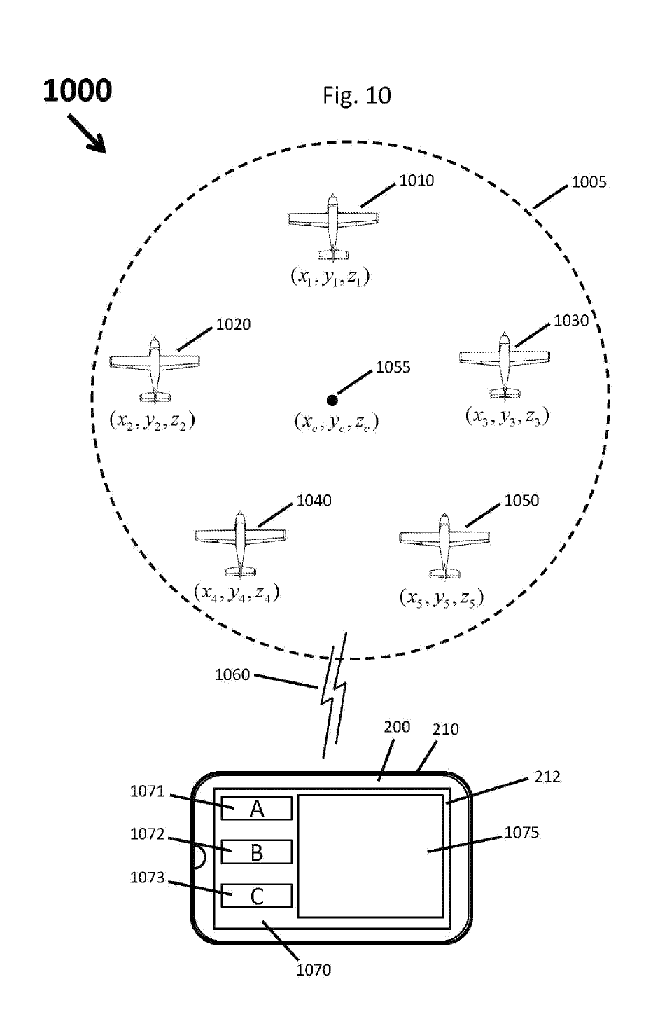

FIG. 10 shows drones 1010 located at (x₁,y₁,z₁), 1020 located at (x₂,y₂,z₂), 1030 located at (x₃,y₃,z₃), 1040 located at (x₄,y₄,z₄) and 1050 located at (x₅,y₅,z₅), forming a swarm 1005 having a centroid 1055 with location (x_{c},y_{c},z_{c}) along with the tablet computer 200 having a monitor 212, with an overall screen 1070 that controls the swarm 1005 (or group of drones 1010, 1020, 1030, 1040, and 1050) using a wireless link 1060. The overall screen 1070 includes buttons, boxes, or image areas 1071, 1072, 1073, and 1075. The centroid location corrdinates, (x_{c},y_{c},z_{c}) are given by

$${x}_{c} = \frac{1}{n} {\sum }_{i = 1}^{n} {x}_{i} , \\ {y}_{c} = \frac{1}{n} {\sum }_{i = 1}^{n} {y}_{i} , \\ {z}_{c} = \frac{1}{n} {\sum }_{i = 1}^{n} {z}_{i} . \qquad ( 1 )$$

In equation (1), n represents the number of drones contained within the swarm 1005, which in FIG. 10 corresponds to five total vehicles.

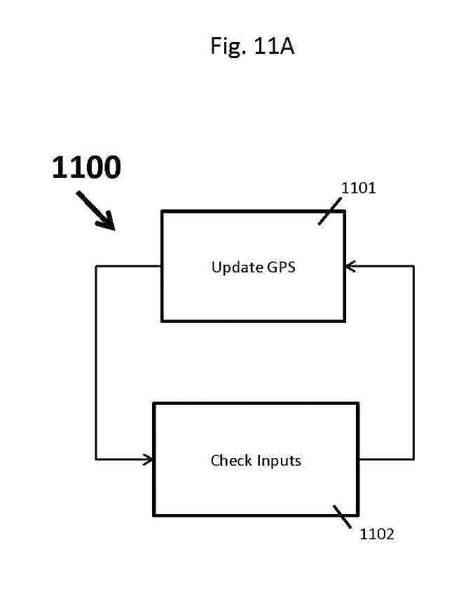

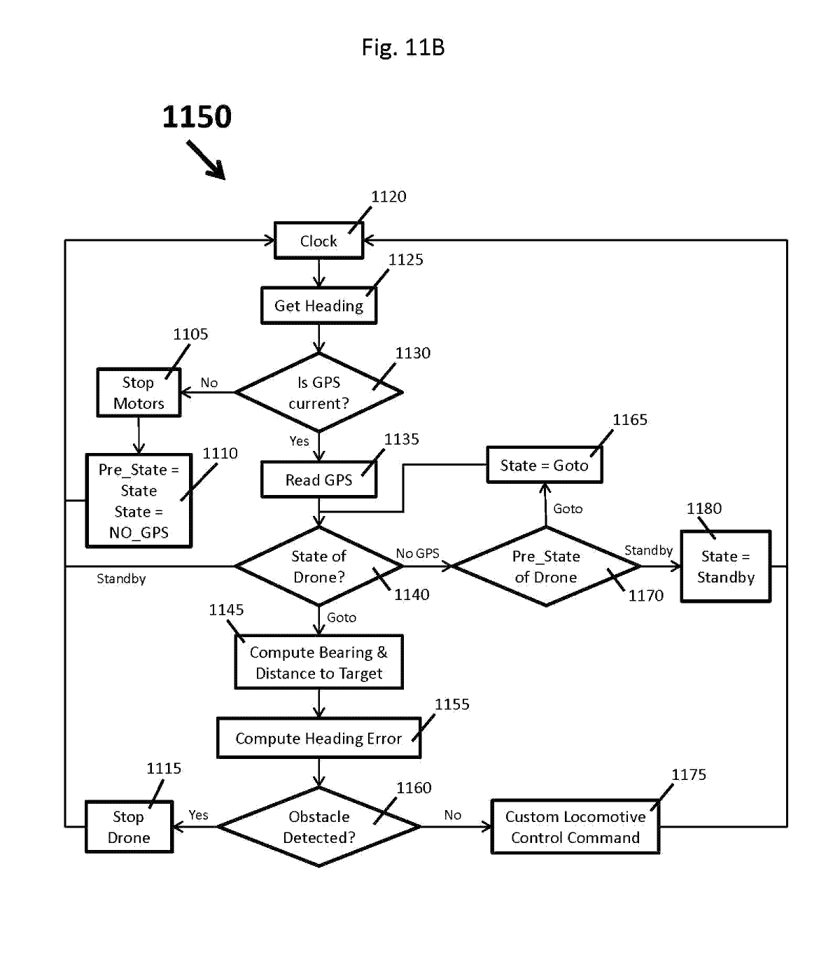

FIG. 11A, FIG. 11B, and FIG. 10 illustrate a specific method for implementing at least one embodiment of the present invention described in FIGS. 1-8. FIG. 11A is a flow chart 1100 which outlines part of a method that can be implemented on an autonomous vehicle or drone in the present invention to update GPS data. The method may include two continuously running loops. The first loop, illustrated in FIG. 11A, runs as fast as the computer processor 4 allows. During the first loop, the computer processor 4 continuously checks a GPS stream at step 1102 of GPS data coming in at transmitter/receiver 6 shown in FIG. 1A, for data and updates a plurality of GPS variables stored in computer memory 2 for every loop. The computer processor 4, is also programmed by computer software to continuously check for user inputs at step 1102. This process is repeated infinitely, by the computer processor 4, at least as long as the computer processor 4, transmitter receiver 6 and the computer memory 2 are powered up.

FIG. 11B is a flow chart 1150 which outlines part of a method that could be implemented on an autonomous vehicle or drone, such as via drone computer processor 106 in an embodiment of the present invention to steer the drone or autonomous vehicle on a desired course. The computer processor 106 begins a second loop by obtaining an accurate heading measurement, 1125, which is calculated using the following equation,

θ_{H}=θ_{compass}θ_{Declination}+Δ(λ,μ)+Δθ_{Deviation}(θ_{H}) (2)

θ_{H}, the magnetic heading is read by the drone computer processor 106 from the drone compass 112. Δθ_{Declination}(λ,μ), the magnetic declination is location specific and in New Jersey is approximately −13.5 degrees. Δθ_{Deviation}(θ_{H}), the magnetic deviation is drone specific and it also varies by direction. An equation for estimating the magnetic deviation is given by

$${Δθ}_{Deviation} ( {θ}_{H} ) = {A}_{o} + {\sum }_{n = 1}^{4} {A}_{n} sin ( n {θ}_{H} ) + {\sum }_{n = 1}^{4} {B}_{n} cos ( n {θ}_{H} ) . \qquad ( 3 )$$

The drone computer processor 106 is programmed by computer software stored in the drone computer memory 102 to calculate the parameters by fitting the function to test data gathered from each particular drone at each of the cardinal directions.

Then the drone computer processor 106 is programmed to check if the current GPS reading, stored in the drone computer memory 102 is current or from more than three seconds ago, at step 1130. If the GPS reading is old then the drone vehicle is stopped, at step 1105, and the loop begins again at step 1120. If the GPS data is current then the GPS data is read by the drone computer processor 106 at step 1135, into the drone computer processor 106 or micro-controller and stored in the drone computer memory 102. Next the drone computer processor 106 checks the current state of the vehicle, 1140, as stored in the computer memory 102. If the vehicle or drone is in Stand-By mode then the loop is restarted by the drone computer processor 106 at step 1120. If the current state is “No GPS”, no GPS signal, then the drone computer processor 106 determines that the drone just established GPS contact and the current state of the vehicle is updated to what it was before it lost GPS signal, 1170. If the vehicle state is currently Goto, step 1165, then the distance and bearing to the desired target/way-point is computed by the computer processor 106 at step 1145. Using the computed bearing and the current heading a heading error is calculated by the computer processor 106, at step 1155, which determines in which way and how much the drone vehicle should turn so as to head in the direction of the target/way-point. Finally, if an object is detected at step 1160, then the vehicle is stopped at step 1115, and the loop is reiterated by the computer processor 106 to step 1120. Otherwise the vehicle's custom locomotion controllers appropriately set the vehicle's parameters based on the heading error at step 1175 and then the loop is reiterated again at step 1120 by the computer processor 106.

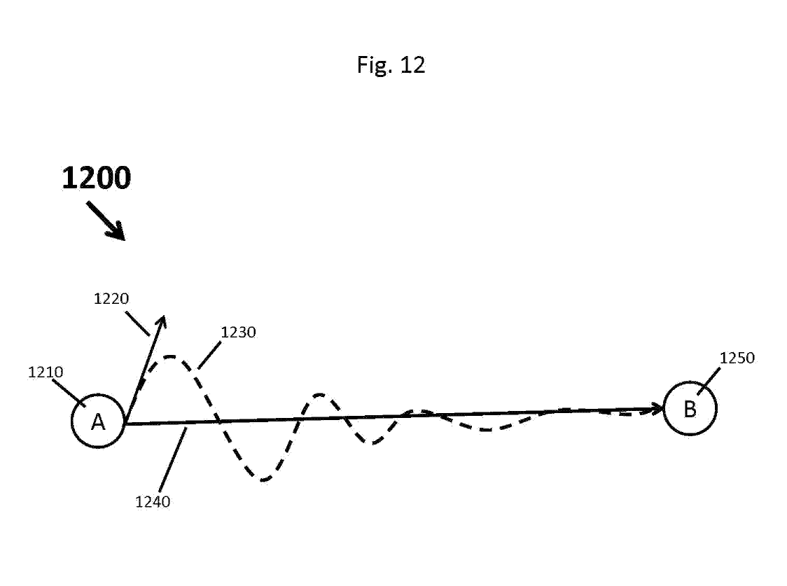

FIG. 12 illustrates a vehicle's autonomous navigation using the example process described in FIG. 8. In each loop through the process, the vehicle's current heading, 1220, and desired bearing, 1240 are determined by the drone computer processor 106, and are then used to calculate the difference between them. The vehicle then moves forward from point A or 1210 and toward the desired target/way-point B, 1250. The item 1230 illustrates a possible path 1230 the vehicle may take to the destination. How fast it moves forward and in what degree towards the target depends on each drone's custom locomotion controller, which may be the drone computer processor 106 as programmed by computer software stored in the computer memory 102. Each controller can be tuned so as to optimize different parameters. Possible objectives which can be optimized are maximum cross track error, rate of oscillations, steady state tracking error, and time to turn toward and reach target/way-point, which can be stored in computer memory 102.

We claim:

1. A method comprising
providing a user input to a handheld computer device;
using a computer processor to respond to the user input to control a plurality of vehicles, wherein the control of each vehicle of the plurality of vehicles is related to the control of the other vehicles of the plurality of vehicles.

2. The method of claim 1 wherein
the user input includes touching a screen of the handheld computer device.

3. The method of claim 1 wherein
the user input is one touch of a screen of the handheld computer device.

4. The method of claim 1 wherein
the user input is a sound provided through a sound input device of the handheld computer device.

5. The method of claim 1 wherein
the user input includes a shape drawn on a screen of the handheld computer device.

6. The method of claim 1 wherein
the user input includes shaking of the handheld computer device.

7. The method of claim 1 wherein
the plurality of vehicles are controlled so that each of the plurality of vehicles stays within a geographic region.

8. The method of claim 7 wherein
each of the plurality of vehicles has a current location, so that there are a plurality of current locations, one for each of the plurality of vehicles;
wherein the geographic region is determined, at least in part by, a geographic center which is based on the plurality of current locations.

9. The method of claim 1 wherein
the plurality of vehicles are controlled so that each vehicle of the plurality of vehicles stays a first distance away from every other vehicle of the plurality of vehicles.

10. The method of claim 1 wherein
the plurality of vehicles are controlled so that each vehicle of the plurality of vehicles stays within a first distance of every other vehicle of the plurality of vehicles.

11. The method of claim 10 wherein
the plurality of vehicles are controlled so that each vehicle of the plurality of vehicles stays a second distance away from every other vehicle of the plurality of vehicles.

12. The method of claim 11 wherein
the first distance is a diameter of a sphere that is centered around a centroid of a combination of all of the plurality of the vehicles.

13. The method of claim 1 further comprising
determining a location of each of the plurality of vehicles by the use of a global positioning system, so that a plurality of locations are determined, one corresponding to each of the plurality of vehicles;
and controlling each of the plurality of vehicles based on one or more of the plurality of locations.

14. A handheld computer device comprising:
a computer processor;
a computer memory; and
a computer interactive device for receiving a user input;
and wherein the computer processor is programmed by computer software stored in the computer memory to respond to the user input to control a plurality of vehicles, wherein the control of each vehicle of the plurality of vehicles is related to the control of the other vehicles of the plurality of vehicles.

15. The handheld computer device of claim 14 wherein
the user input includes touching a screen of the handheld computer device.

16. The handheld computer device of claim 14 wherein
the user input is one touch of a screen of the handheld computer device.

17. The handheld computer device of claim 14 wherein
the user input is a sound provided through a sound input device of the handheld computer device.

18. The handheld computer device of claim 14 wherein
the user input includes a shape drawn on a screen of the handheld computer device.

19. The handheld computer device of claim 14 wherein
the user input includes shaking of the handheld computer device.

20. The handheld computer device of claim 14 wherein
the plurality of vehicles are controlled so that each of the plurality of vehicles stays within a geographic region.

21. The handheld computer device of claim 20 wherein
each of the plurality of vehicles has a current location, so that there are a plurality of current locations, one for each of the plurality of vehicles;
wherein the geographic region is determined, at least in part by, a geographic center which is based on the plurality of current locations.

22. The handheld computer device of claim 14 wherein
the plurality of vehicles are controlled so that each vehicle of the plurality of vehicles stays a first distance away from every other vehicle of the plurality of vehicles.

23. The handheld computer device of claim 14 wherein
the plurality of vehicles are controlled so that each vehicle of the plurality of vehicles stays within a first distance of every other vehicle of the plurality of vehicles.

24. The handheld computer device of claim 23 wherein
the plurality of vehicles are controlled so that each vehicle of the plurality of vehicles stays a second distance away from every other vehicle of the plurality of vehicles.

25. The handheld computer device of claim 24 wherein
the first distance is a diameter of a sphere that is centered around a centroid of a combination of all of the plurality of the vehicles.

26. The handheld computer device of claim 14 wherein
the computer processor is programmed to determine a location of each of the plurality of vehicles by the use of a global positioning system, so that a plurality of locations are determined, one corresponding to each of the plurality of vehicles;
and the computer processor is programmed to control each of the plurality of vehicles based on one or more of the plurality of locations.
